(19) United States
(12) Patent Application Publication
(10) Pub. No.: US 2009/0277826 A1
(43) Pub. Date: Nov. 12, 2009

(54) HOLLOW FIBRE MEMBRANE MODULE

(76) Inventors: Steven K. Pedersen, Burlington (CA); Pierre Lucien Cote, Dundas (CA); Simon Levesque, Levis (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/117,007

(22) Filed: May 8, 2008

(51) Int. Cl. B01D 63/04; B32B 37/00

(52) U.S. Cl. 210/321.78; 156/250

(57) ABSTRACT

A module has a housing and a tube-sheet. Hollow fiber membranes are potted in the tube-sheet with their ends open. Mechanical interference prevents excessive movement of the tube-sheet along the length of the housing. A gasket is placed in a groove between the tube-sheet and the housing, opening towards the outer face of the tube-sheet. A cap is secured and sealed to the end of the housing. To construct the module, membranes are placed inside of the housing with their ends protruding. A potting fixture is attached to the end of the housing over the ends of the membranes and protruding into the end of the housing so as to form the groove. Liquid potting material is injected into the potting fixture and solidified into a tube-sheet. The potting fixture is removed and the ends of the fibers are cut open. The module may be used, for example, to dehydrate a fermentation product vapour mixture fed through the lumens of the fibres by extracting water vapour permeated into the housing under partial vacuum.

### FIELD

This specification relates to hollow fibre membrane modules and methods of making them.

### BACKGROUND

The following background description is not an admission that anything discussed herein is prior art or part of the common general knowledge of persons skilled in the art.

A polyimide hollow fibre membrane is described in US Publication No. 2006/0117955 which is incorporated herein by this reference to it. These membranes may be used, for example, for to remove water vapour from vapour mixtures containing fermentation products such as ethanol.

Multiple segments of hollow fibre membrane may be grouped together into modules by potting their ends in one or two tube-sheets. The tube-sheets and membranes are assembled with a shell so as to create a shell side plenum between the outsides of the membranes and the inside of the shell. Caps placed over the open ends of the fibers at the tube-sheets complete a lumen side plenum. The lumen side plenum is separated from the shell side plenum except for by way of permeation through the membrane walls. Subject to numerous considerations, permeation can occur through the membranes in either direction such that either the feed side or the shell side may be used as the feed side or the permeate side. Transmembrane pressure (TMP) may be applied to withdraw permeate by way of feed side pressure, permeate side suction, or both. With high TMP, significant forces are created on the tube-sheets. Using shell side feed reduces these forces because the area of the tube-sheet occupied by the fibers reduces the area of the tube-sheet exposed to the TMP. Using shell side feed also allows the outside face of the tube-sheet to be supported against a module end plate but a large, complex module may result and the feed side hydraulics may be poor.

In addition to the forces on the tube-sheets, module design is complicated by the need to cast the tube-sheet around the membrane ends, produce open ends of the membranes exposed to the outside of one or both tube-sheets, locate the membranes inside the shell, use materials that are chemically resistant to the intended feed substances, and create robust seals between the solidified tube-sheets, the shell and the caps. Making robust seals is complicated by the need to account for different materials used in the shell and the tube-sheet. In particular, the shell and tube-sheets tend to expand at different rates in response to temperature changes or absorption of components in the feed. To deal with these issues, arrangements of numerous gaskets or other components are often required.

### SUMMARY

The following summary is intended to introduce the reader to the disclosure and not to limit or define any claimed invention.

A module is described having a housing and a tube-sheet at one end. Hollow fiber membranes are potted in the tube-sheet with their ends open at the outer face of the tube-sheet. The tube-sheet and housing have corresponding features of shape providing mechanical interference against movement of the tube-sheet along the length of the housing. A gasket is placed in a groove between the tube-sheet and the housing, the groove opening towards the outer face of the tube-sheet. A cap is secured and sealed to the end of the housing. Optionally, the cap or a seal between the shell and cap may cover all or part of the groove to mechanically capture the gasket. If both ends of the membranes are to be open, a similar construction may be used at the other end of the module.

A method of constructing a module is described. A bundle of membranes are placed inside of a housing with their ends protruding from the housing. A potting fixture is attached to the end of the housing over the ends of the membranes. The potting fixture protrudes into the end of the housing around an inside edge of the housing. Liquid potting resin is injected into the potting fixture and cured into a tube-sheet around the ends of the membranes. The potting fixture is removed and the ends of the fibers are opened by cutting through the tube-sheet close to the end of the housing. A gasket is placed inside a groove left when the protruding portion of the potting fixture was removed. A cap is attached over the end of the housing.

The module has utility for separating a mixture of gases, which may be a mixture of vapours or include vapours. One particular example is dehydrating fermentation broths that have been converted to vapour mixtures for example by boiling, distillation or pervaporation. The fermentation broths may include ethanol, ABE or other substances useful as fuel. The vapour mixture may be fed under pressure into one end of the lumens of the fibres, with a mixture reduced in water vapour concentration produced at the other end of the fibers, and water vapour enriched permeate withdrawn from the shell side under a partial vacuum. While this example is given to demonstrate that the module has utility, the module may also be used for other purposes.

### BRIEF DESCRIPTION OF FIGURES

FIGS. 1 and 2 are side and isometric views of a module housing.

FIG. 3 is an exploded cross-sectional view of an end of a module having a housing as in FIG. 1.

FIG. 4 is an assembled cross-sectional view of the end of the module shown in FIG. 3.

FIG. 5 is a cross-sectional view of the end of the module shown in FIG. 3 during an intermediate step in a process of potting membranes.

FIG. 6 shows a set of completed modules assembled into a rack.

### DETAILED DESCRIPTION

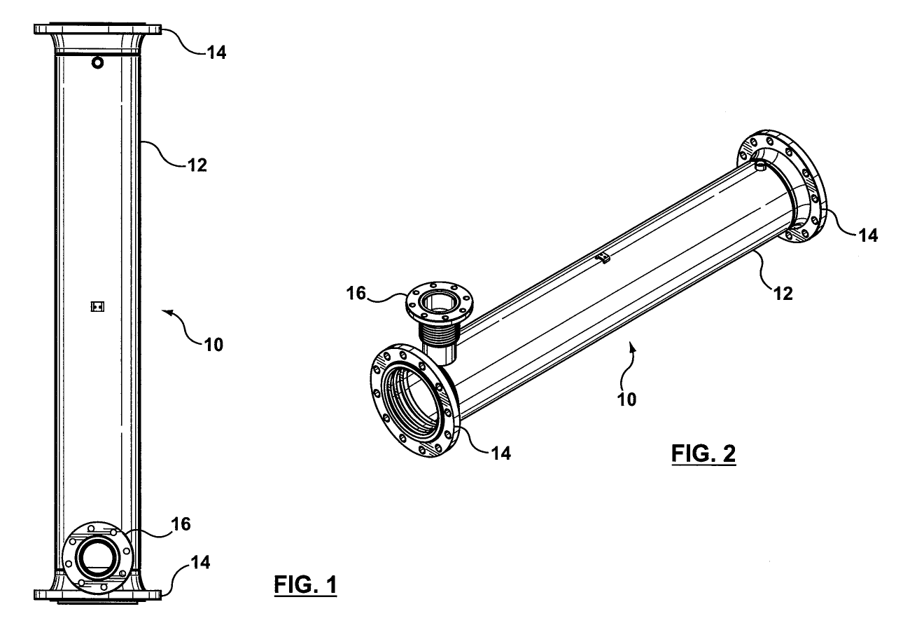

FIGS. 1 and 2 show a housing 10. The housing is made of a section of tubing 12 with two end flanges 14 attached one at each end. A shell side port 16 is provided at one end of the housing 10. Optionally, a second shell side port can be added at the other end of the housing if a shell side sweep is desired. The housing 10 shown is made of stainless steel with the flanges 14 and shell side port 16 welded to the tube 12, although other materials or methods of assembly might be used.

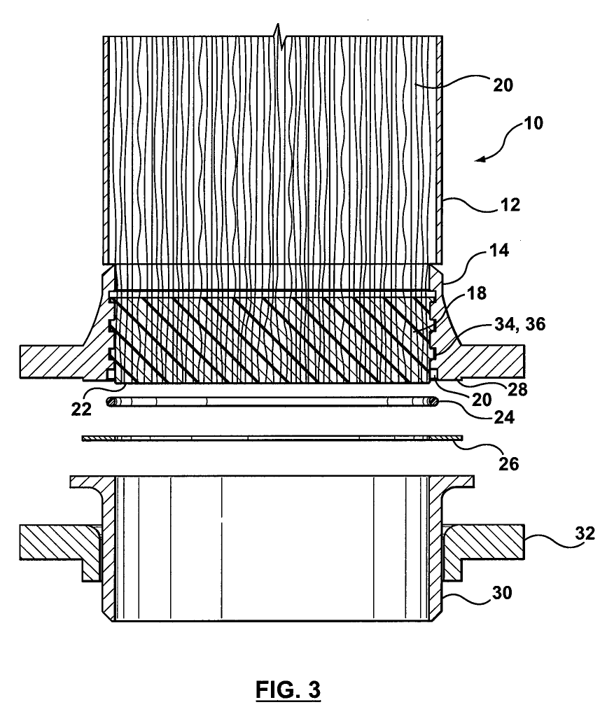

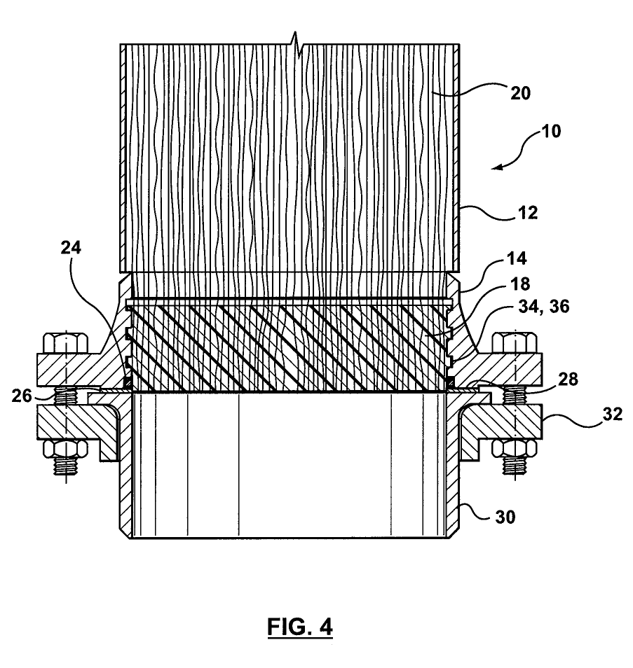

Referring to FIGS. 3 and 4, a tube sheet 18 is located inside the flange 14. The tube sheet 18 is made of a solidified potting material cast around the ends of numerous membranes 20. In the Figures, only a few membranes 20 are shown to simplify the drawing although in practice there may be thousands. The ends of the membranes 20 are open and optionally flush with the outside face 22 of the tube-sheet 18. The outside face 22 of the tube sheet 18 may protrude by a small distance from the end 28 of the flange 14, but preferably is close to the end of the flange 14. Ridges 34 in the tube-sheet 18 fit inside of recesses 36 in the flange 14 to hold the tube-sheet 18 in the flange 14. A groove 20 between the circumference of the tube-sheet 18 and the inside of the flange 14 opens to an outside face 22 of the tube-sheet 18. An O-ring gasket 24, for example of elastomeric material, is inserted into the groove 20. A flat gasket 26 covers the end of the flange 14. A cap 30, which may be a section of feed or retentate piping, is attached to the flange 14. In the example shown, the cap 30 buts against the flat gasket 26 and is bolted by way of a lap flange 32 to the flange 14. The flat gasket 26 provides a seal between the cap 30 and the flange 14. Preferably, the flat gasket 26 or the cap 30 cover some or all of the opening of the groove 20 to trap the O-ring gasket 24 in the groove 20. Optionally, the O-ring gasket 24 may be replaced by a flexible sealing material formed in place to the shape of at least the inner part of groove 20. For example, silicone rubber can be poured or squeezed into the groove 20. The sealing material may undergo a physical or chemical change to a more viscous or solid form after being placed in the groove 20. The sealing material is preferably chosen to be one that will adhere to the tube-sheet 18 and flange 14 and be flexible enough to accommodate changes in groove 20 width, for example due to thermal expansion.

The O-ring gasket 24 provides a seal between the tube-sheet 18 and the flange 14 to separate the lumen side and shell side of the module. It is not necessary to seal the cap 30 to the tube-sheet 18. The O-ring gasket 24 is sized to account for shrinkage of the tube-sheet 18 during curing and thermal expansion of the flange 14. Pressure applied in use by gases fed into the lumens of the membranes 20 though the cap 30, or by suction on the shell side port 16, pushes and compresses the O-ring gasket 24 into the groove 20. In the example applications described in the introduction, with feed gases flowing though the lumens of the membranes 20 and shell side suction, the feed pressure relative to suction on the port 16 is such that O-ring gaskets on both the feed and product/retentate sides of the housing 12 are drawn into the grooves 20. The membranes 20 in the example applications are not backwashed but pressure may be applied in the reverse direction during integrity tests. During integrity tests, the test pressure may be high enough to move the O-ring gaskets 24 out of the grooves 20 but the O-ring gaskets 24 are retained in the groove 20 by the flat gasket 28 or cap 30.

The tube-sheet 18 may be made of, for example, epoxy resin. The resin does not stick to various other materials, for example stainless steel, that could be used for the flange 14. The tube-sheet 18 may also shrink during curing and expand less than the flange 14 when heated. The tube-sheet 18 is therefore likely to have an outer diameter slightly less than the inside diameter of flange 14 when first put in use. The tube-sheet 18 may expand as it absorbs some of the feed components and the initial shrinkage of the tube-sheet 18 provides a useful allowance for this expansion. Over time, the tube-sheet may expand to the point that it bears against the inside of the flange 18. However, even then any resulting pressure is unlikely to cause sufficient friction to overcome forces against the tube-sheet 18 along the length of the housing 10 created by the TMP.

The ridges 34 and recesses 36 are shaped to provide mechanical interference preventing the tube-sheet 14 from being pushed along the length of the housing 10 in use. For example, the recesses 36 may be generally square sectioned annular grooves. In this case, the housing 10 can be re-used by breaking the tube-sheet 18 and removing it in pieces. The membranes 20 can be cut through port 16 to allow the pieces of tube-sheet 18 to be removed. Alternatively, the recesses 36 may be cut in a spiral thread form. This allows the tube-sheet 18 to be screwed out of the housing 10 to re-use the housing 10 after the membranes 20 have exceeded their service life.

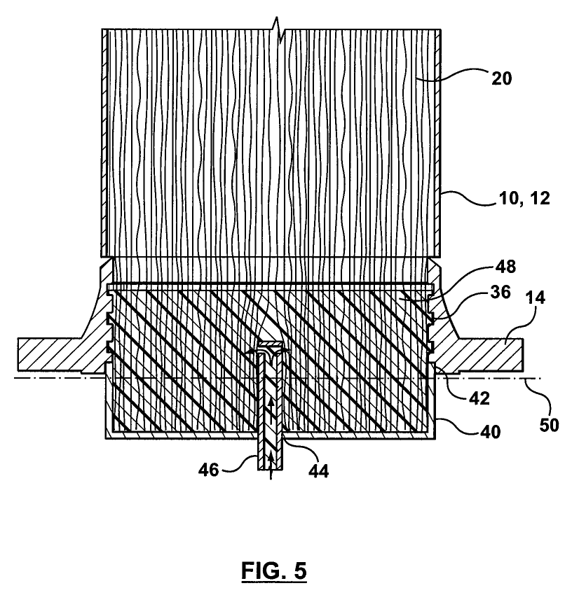

The membranes 20 are potted as part of a process of casting the tube-sheet 18 in the flange 14. Referring to FIG. 5, one or more bundles of membranes 20 are placed in the housing 10 with their ends protruding from the end of the housing 10. A potting fixture 40 is attached to the end of the housing 10 and fills a notch in the end of the flange 14. The membranes 20 are typically inserted into the housing 10 before the potting fixture 40 is added, although at one end of the housing 10 the order of these steps can be reversed. The potting density of the membranes 20 is typically large enough, for example 45-55% to prevent the membranes 20 from moving excessively during potting.

The potting fixture 40 has one or more ports 44 that admit one or more nozzles 46. Nozzle 46 is used to inject liquid potting material 48, for example polyester resin, into the flange 14 and potting fixture 40. After the potting material 48 has been injected, nozzle 46 may be removed from port 44 and replaced by a plug (not shown). Alternately, nozzle 46 may be left in potting material 48. The potting material 48 flows around the ends of the membrane 20 and into the recesses 36 and then is allowed to solidify in situ. The potting fixture 40 may be wrapped with a coil of tubing or covered by a jacket to allow a heated or cooled liquid to be circulated around it to control the temperature profile of the potting material 48 as it solidifies. If the potting material 48 would also flow into the ends of the membranes 20 up to the height of the bottom of the flange 14, the ends of the membranes 20 may be sealed before the membranes 20 are placed in the housing 10. After the potting material 48 has at least partially solidified, the potting fixture 40 is removed. The block of potting material 48 is later cut along cut line 50 to open the ends of the membranes 20. The assembly may be shipped at this stage, with the membranes 20 protected inside the housing 10, or after the gaskets 24, 26 and cap 30 are added.

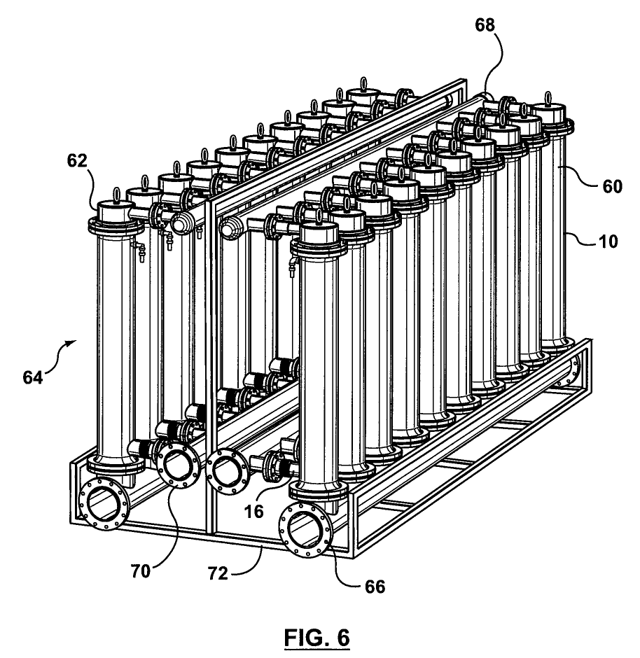

If a module is being made for dead end flow only, the other ends of the membranes 20 may be sealed and the other end of the housing 10 capped or otherwise closed. Alternately, as shown in FIG. 6, a module 60 can be made with the membranes 20 potted with their ends open at both ends of the housing 10. In that case, the steps described above are also performed to pot the membranes 20 and form a tube-sheet 18 at the other end of the module 60. If the steps above were performed statically, with the housing 10 vertically and the potting material 48 flowing by gravity, then the housing is inverted after a first tube-sheet 18 is formed to allow the second tube-sheet 18 to be formed. In the module 60 shown, the membranes 20 are integrally skinned poyimide membranes as described in US Publication No. 2006/0117955 and available from Vaperma Gas Separation Solutions under the trademark SIFTEK. These membranes have a sufficiently high Tg to allow the potting material 48, epoxy resin, to be used at 70-100 C. At this temperature, viscosity of the potting material 48 is low enough to allow the potting material to penetrate into the bundle of membranes 20 under the force of gravity and surface attractions alone. Alternately, if a more viscous potting material 48 will be used, or if it is desirable to form both tube-sheets 18 simultaneously, the tube-sheets 18 may be formed in a centrifuge.

Still referring to FIG. 6, a second cap 62 at the other end of the module 60 may optionally have a different configuration from the cap 30. Several modules 60 may be joined together to form a rack 64. The caps 30 may be attached to or be part of a feed manifold 60. Second caps 62 may be attached to or be part of a retentate header 68. Ports 16 may be connected to a permeate header 70. All of these components may be mounted to a frame 72. A bellows or other means may be used in one or more locations, for example adjacent the ports 16, to allow for manufacturing tolerances. For other applications, different arrangements of modules 60 and piping may be made.

In one example, a module 60 has a length of about 180 cm and a diameter of about 25 cm. The module 60 contains about 28,000 hollow fibre membranes 20. The membranes are integrally skinned polyimide membranes as described above, formed for inside out permeation. The membranes 20 have an outside diameter in the range of about 0.5 to 1.5 mm, for example about 1.0 mm, an inside diameter of about 0.2 to 1.0 mm, for example about 0.7 mm, and an OD/ID ration of between about 1.3 to 2.0. The membranes 20 are potted at both ends and about 20 modules 60 are provided in a rack 64 as shown in FIG. 6. The modules 60 are used by feeding a vapour mixture, for example vapours including water extracted from a fermentation broth, at high temperatures and under pressure to the feed manifold 60. The vapour mixture flows through the lumens of the membranes 20 and out to the retentate header 68. Water vapour is preferentially permeated through the walls of the membranes 20 via the driving force of a vacuum applied to the permeate header 70. The retentate/product is a dehydrated vapour mixture. Under appropriate process conditions, and optionally with multiple stages of modules 60, the retentate may be sufficiently dehydrated to be condensed and used as a fuel or fuel supplement.

I/We claim:

1. A module comprising,
a) a housing;
b) a tube-sheet at an end of the housing;
c) hollow fiber membranes potted into the tube-sheet with their ends open at an outer face of the tube-sheet; and,
d) a gasket placed in a groove located between the tube-sheet and the housing and opening towards the outer face of the tube-sheet,
wherein,
e) the tube-sheet and housing have corresponding features of shape providing mechanical interference against movement of the tube-sheet along the length of the housing.

2. The module of claim 1 further comprising a cap secured and sealed to the end of the housing.

3. The module of claim 2 wherein the cap or a seal between the housing and the cap covers all or part of the groove so as to mechanically capture the gasket.

4. The module of claim 1 having elements b) to e) at another end of the housing.

5. The modules of claim 1 wherein the features of shape providing mechanical interference are configured in a spiral extending inwards from the end of the housing.

6. A method of constructing a module comprising steps of,
a) placing a bundle of membranes inside of a housing with their ends protruding from the housing;
b) attaching a potting fixture to the end of the housing and over the ends of the membranes, the potting fixture protruding into the end of the housing around an inside edge of the housing;
c) after steps a) and b), placing liquid potting material into the potting fixture and around the ends of the membranes within the end of the housing;
d) solidifying the liquid potting material;
e) removing the potting fixture; and,
f) cutting the solidified potting material outside of the end of the housing to open the ends of the fibers.

7. The method of claim 6 wherein the inside of the end of the housing is grooved and potting material is cast into the grooves.

8. The method of claim 6 further comprising a step of placing a gasket inside a groove left when the protruding portion of the potting fixture was removed.

9. The method of claim 8 wherein the step of placing the gasket inside the groove further comprises forming the gasket to correspond to the shape of the groove in situ.

10. The method of claim 6 further comprising attaching a cap over the end of the housing.
